(19) United States
(12) Patent Application Publication
(10) Pub. No.: US 2007/0020449 A1
(43) Pub. Date: Jan. 25, 2007

(54) Printed images on mats

(76) Inventor: Doreen Hing, Boston, MA (US)

Correspondence Address: WOLF GREENFIELD & SACKS, PC, FEDERAL RESERVE PLAZA, 600 ATLANTIC AVENUE, BOSTON, MA, 02210-2206, US

(21) Appl. No.: 11/189,408

(22) Filed: Jul. 25, 2005

(51) Int. Cl. B32B 9/00

(52) U.S. Cl. 428/318.4; 428/76

(57) ABSTRACT

A flexible substrate or mat incorporating an image is provided. The mat may include a flexible sheet of a plastic foam. The sheet may include an image at least partially embedded into at least a portion of the sheet, and the tackiness of a first side of the sheet may be minimally affected by the image. The image may be formed by inks, such as solvent inks, or UV curable inks. The mat may be made of a plastic or a rubber, and it may be sized and shaped for use as a yoga mat. The image may be a digital image.

### FIELD OF THE INVENTION

The present invention relates to a flexible substrate with a printed image, and in particular to a yoga mat with an image applied to the mat.

### BACKGROUND OF THE INVENTION

Various types of flexible substrates exist, for use in a variety of applications. For example, flexible substrates are used as cushioning and supportive surfaces for numerous types of athletic activities. In gymnastics and wresting, floor and wall mats of varying sizes and thicknesses are used to cushion landings, protect against injury, and may provide some rebounding characteristics. Also, activities such as yoga and pilates are typically performed on a flexible mat substrate.

Other types of flexible substrates have non-athletic applications. For example, flexible substrates may be formed into computer mouse pads, insulator panels, wall panels, bath mats, door mats, pool mats, etc.

The above substrates may be manufactured using several techniques. For example, some flexible substrates, such as gymnastic mats, may consist of a softer foam core within a plastic vinyl shell. Other substrates may be made of a more durable foam material. For example, yoga mats are typically made from a closed cell foam.

Yoga mats are typically manufactured from a closed cell foam material that exhibits at least one side with a tacky outer surface. This type of yoga mat is commonly referred to as a “sticky mat”. This tacky or sticky quality is a beneficial characteristic for a yoga mat because it provides a slip-resistant and/or a non-slip surface. Activities such as yoga, are commonly performed with bare feet, and many yoga poses require a person to place hands, feet, elbows, and/or knees on the yoga mat. During the course of a yoga class, it is common for a person to perspire, causing hands and feet to sweat. The slip resistant surface of a yoga mat helps a person hold a yoga pose without sliding or slipping out of position. Sliding is generally not desirable with yoga, as it may also strain muscles. The slip resistant surface of a yoga mat may be a quality of the foam material used to manufacture the yoga mat.

Many yoga mats are made of one solid color. Some yoga mats have a simple pattern across the entire mat, like a stripe pattern. However, these simple patterns are formed during the foam molding process. For instance, two colors of resin may be used to manufacture the mat itself.

Some yoga mats have small logos or designs printed directly onto the yoga mat. Such logos and designs are typically silk screened on top of the mat. Silk screened surfaces are generally smoother and less tacky in comparison to the surface of the yoga mat itself. These small silk screened logos are often placed near an edge or corner of the yoga mat.

### SUMMARY OF INVENTION

In one embodiment of the invention, a mat is provided. The mat includes a flexible sheet of plastic foam that a user may manually by hand roll up and unroll, repeatedly, the flexible sheet includes a first tacky side defining a user contacting side and a second side defining a ground contacting side. The first tacky side of the flexible sheet includes an intermediate body portion and an external border portion surrounding the intermediate body portion. The sheet incorporates a digital image along at least a portion of the body portion, and the sheet incorporates the image along at least about 25% of the first tacky side of the flexible sheet.

In another embodiment, a flexible substrate is provided. The flexible substrate includes a sheet of flexible material that a user may manually by hand roll up and unroll, repeatedly, the sheet has a first side having a surface tackiness defined by a static coefficient of friction relative to a skin-like surface. At least a portion of the first side incorporates an image, where the surface tackiness of the first side of said sheet is minimally affected by the image. The static coefficient of friction relative to a skin-like surface of the first side at a location of the image is at least about 80% of the static coefficient of friction of a first side of a same type sheet of flexible material without an image.

In yet another embodiment, a method of applying an image to a flexible substrate is provided. The method includes the steps of providing a flexible substrate that a user may manually by hand roll up and unroll, repeatedly, where the flexible substrate has a first tacky side, and applying an image to the first tacky side. The image is formed from an ink, and the ink is applied such that the ink becomes at least partially embedded into the flexible substrate.

In another embodiment, a mat is provided. The mat includes a flexible sheet that a user may manually by hand roll up and unroll, repeatedly, the flexible sheet having a first side defining a body contacting surface, and a second outer surface defining a ground contacting surface. The mat further includes an image at least partially embedded into the first side, where the image is formed from a solvent ink.

### BRIEF DESCRIPTION OF DRAWINGS

The foregoing and other objects and advantages of the invention will be appreciated more fully from the following drawings, wherein like reference characters designate like features, in which:

FIG. 1 is a side view of a flexible substrate with an image printed on top of a first surface of the substrate;

FIG. 2 is a side view of a flexible substrate with an image embedded into a first surface of the substrate;

FIG. 3 is a perspective view of one embodiment of a flexible substrate constructed and arranged for use as a yoga mat;

FIG. 4 is a top view of an image printed on a first surface of a flexible substrate;

FIG. 5 is a top view of an image printed on a first surface of a flexible substrate;

FIG. 6 is a top view of an image printed on a first surface of a flexible substrate;

FIG. 7 is a top view of an image printed on a first surface of a flexible substrate; and

FIG. 8 illustrates the testing procedure for measuring the stiction force and the static coefficient of friction for various substrates.

### DETAILED DESCRIPTION

The present invention provides a flexible substrate or mat incorporating an image. The term “incorporating” for the purpose of this application is meant to include embodiments where the image is printed on and/or beneath a surface of the substrate. A user may manually roll and unroll the substrate, repeatedly, without defacing the image.

Applicant recognizes certain disadvantages with flexible substrates when an image is adhered to the substrate. In particular, Applicant recognizes that the surface qualities of the flexible substrate are affected by the placement of an image on top of the substrate. Accordingly, some aspects of the invention relate to a flexible substrate having an image applied to at least a portion of the substrate, where the surface qualities of the substrate are not substantially altered by the image. Applicant has experimented with various types of images and printing processes, and has discovered that solvent ink printing is one way to incorporate an image to a substrate without drastically affecting the surface characteristics of the substrate. As discussed below, in some embodiments, the solvent ink image applied to a mat exhibits a static coefficient of friction relative to a skin-like surface that is at least about 80%, 85%, 90%, and 95% of the coefficient of friction for conventional mat.

With respect to yoga mats, Applicant found that most are made with just one color. Some mats have a simple design that may use more than one color, but these designs are typically formed during the molding process. Although these mats include more than one color, this method of adding a design during the molding process has the following disadvantages:

(1) The design is typically limited to simple linear arrangements;

(2) The design is set at the initial manufacturing stage of the mat; and

(3) It is difficult to create an intricate or detailed design on the mat.

According to one embodiment of the present invention, one or more of the above disadvantages are overcome.

Silk screening may produce a more complex design in comparison to designs produced during the molding process. However, Applicant found that silk screening reduces and/or eliminates the surface tackiness of the yoga mat. Therefore, silk screened designs on a yoga mat are often limited to smaller border regions of the mat. These smaller designs are typically placed close to an edge of the yoga mat, and cover a portion of the mat that a hand or foot, etc., is less likely to contact. Accordingly, it is another aspect of the present invention to provide a flexible substrate having an image at least partially embedded into the substrate, such that the surface properties of the substrate are not substantially altered.

Further, as shown in FIG. 3, which illustrates a user 40 on a yoga mat 50, the substrate may be defined as including both an intermediate body portion 52 and an external border portion 54. The external border portion 54 includes the portions of the mat adjacent the perimeter edge of the substrate, and the intermediate body portion 52 is surrounded by the external border portion 54. In one embodiment, the border portion 54 extends about 3 inches wide around the perimeter of the mat 50, and the body portion 52 is defined as the portion of the mat 50 where a user 40 is predominately contacting with parts of their body, such as with their hands and feet. In one embodiment, the substrate incorporates an image along at least a portion of the intermediate body portion 52 of the substrate. The image may cover at least about 25%, 35%, 50%, 75%, 90%, 95%, or 100% of the substrate.

As described in further detail below, in one embodiment an image is applied to at least a portion of a first side of a flexible material. The static coefficient of friction relative to a skin-like surface of the first side at a location of the image is at least about 80% of the static coefficient of friction of a first side of a same type sheet of flexible material without an image. In other embodiments, the static coefficient of friction relative to a skin-like surface of the first side at a location of the image is at least about 85%, 90%, or 95% of the static coefficient of friction of a first side of a same type sheet of flexible material without an image.

Some aspects of the invention are directed to a flexible substrate that may be used for various types of athletic activities. The flexible substrate may include a digital image disposed over a portion of the substrate. In one embodiment, the flexible substrate is sized and shaped for use as a yoga mat, pilates mat, or exercise mat. However, in other embodiments, the substrate may be larger and/or thicker, configured for use as a wrestling mat, or a gymnastics tumbling mat. In some embodiments, the flexible substrate may be used to provide padding and cushioning, and it may be placed on walls or floors, etc.

Other aspects of the present invention are directed to a flexible substrate for non-athletic types of applications, such as computer mouse pads, insulator panels, wall panels, etc. In some embodiments, the substrate is constructed and arranged for use as flooring, such as bath mats, door mats, or mats to place around a pool, etc. It should be appreciated that according to some embodiments of the invention, the invention is not especially constructed for a particular end-use application.

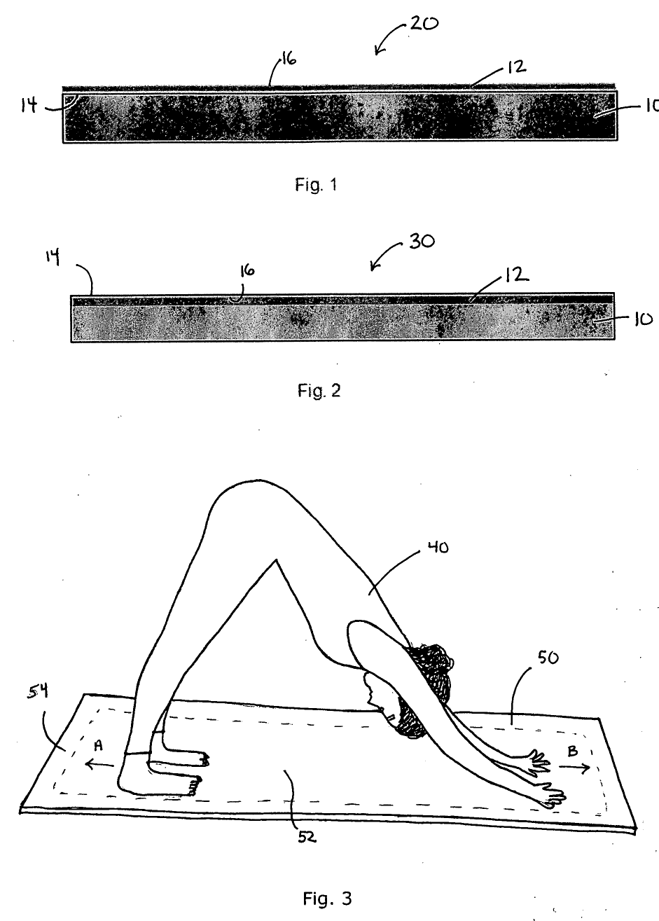

Turning now to the drawings, and in particular with reference to FIGS. 1 and 2, two flexible substrates 20, 30 will be described and compared. The substrate 20 featured in FIG. 1, includes a sheet 10 of material having an image 12 printed on top of the outer surface 14 of the sheet 10. Because the image 12 is positioned over the sheet 10, the top surface of the substrate 20 is no longer the outermost sheet surface 14. Rather, the image 12 becomes the top surface of the substrate 20. Therefore, the surface properties of the substrate are greatly affected by the image 12. This type of layered image shown in FIG. 1, is typical with some printing processes, such as silk screening.

In contrast, the substrate 30 illustrated in FIG. 2 features a sheet 10 of material with an image 12 embedded into the sheet 10. In this embodiment, the top surface of the flexible substrate 30 remains the outer surface 14 of the sheet 10. With this type of embedded image, the surface properties of the substrate 30 are either not affected, or are minimally affected by the presence of the image 12. One aspect of the present invention features a flexible substrate 30 with an embedded image, as illustrated in FIG. 2. Other aspects of the present invention features a flexible substrate with an image at least partially embedded into the substrate.

Image

An image may be applied to the substrate by a variety of techniques. As described in further detail below, an image may be applied to the substrate with UV curable inks, or with solvent inks. In one embodiment of the present invention, a digital image is applied to the flexible substrate. And according to one embodiment, a digital image is applied to a yoga mat.

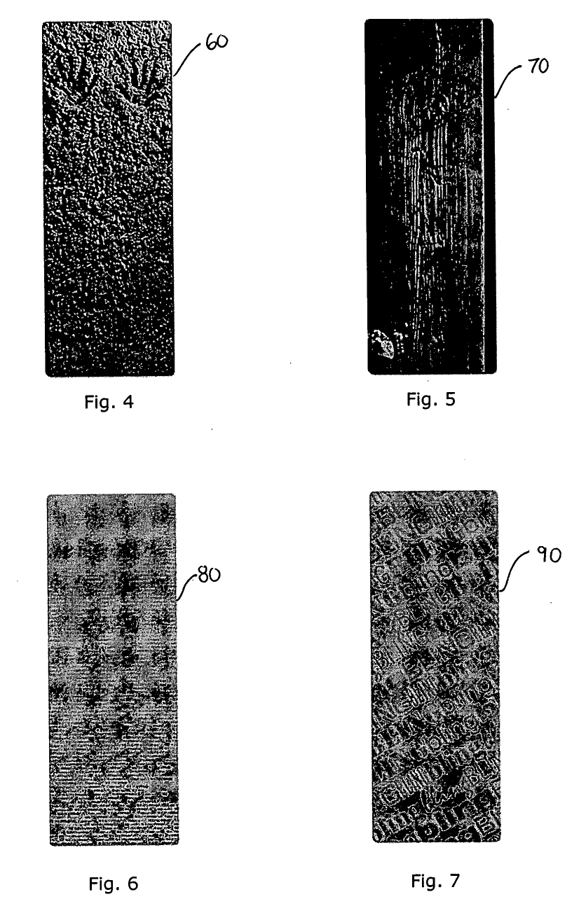

A variety of types of images, such as digital photos, designs, text, etc. may be applied to the substrate, as the present invention is not limited in this respect. For example, FIGS. 4-7 illustrate some possible images, which are applied to substrates 60, 70, 80, and 90. FIGS. 4 and 5 have photographic digital images which cover the entire substrate 60, 70. FIG. 4 illustrates a detailed image of a handprint in plush carpeting, and FIG. 5 illustrates a wooden plank. Although the present invention may incorporate any image with a substrate, FIGS. 4 and 5 are representative of the level of detail that one may achieve with an image and substrate according to the present invention. FIGS. 6 and 7 feature images that cover the majority of the substrate 80, 90. In particular, rather than using a photograph digital image, the images featured in FIGS. 6 and 7 include a text image. Text images may vary in size and placement across the mat, and may repeat phrases or expressions, etc. In one embodiment, substrates 60, 70, 80, and 90 are yoga mats.

The images may be applied to the substrate with various types of inks. Inks are primarily made up of two components, the colorant and the carrier. The carrier is the component that helps transport the colorant to the media. Carriers are typically water-based or solvent-based. The colorant is what determines the color that one sees when looking at the ink. Colorants are typically either dyes or pigments. The primary difference with dye and pigment based inks is the complexity and size of the ink particles. A pigment particle is typically made up of numerous molecules bonded together, while a dye particle is typically made up of one molecule. Pigment-based inks are often water soluble and less sensitive to humidity, while dye-based inks are water soluble and may be more susceptible to the adverse effects of humidity.

In one embodiment of the present invention, the image is at least partially embedded into the substrate layer. One method of embedding the image into the substrate layer involves the use of solvent inks. Solvent inks are similar to water-based pigmented ink, except that the colorant of a solvent ink is immersed in a much more aggressive carrier in comparison to a water-based ink. Due to the aggressiveness of the solvent carrier, the ink may bond to the substrate layer, rather than remain as a top coat. Solvent inks may be described as biting into, bonding, or staining the substrate, such that the ink and the substrate become more like one component. Solvent inks generally dry through rapid evaporation. Once solvent ink dries, the ink becomes impregnated into the substrate and therefore adheres to the material more than if it was just placed on top of the material. This is in contrast to an aqueous or water-based ink which would not be embedded into the material.

A printer used to apply the solvent ink may have either piezo or thermal print heads. Piezo print heads release ink by the application of pressure to the nozzle chamber on the print head, which forces a drop of ink onto the media to create an image. In particular, a piezo crystal located behind the nozzles in the print head are charged with electricity which pulls and then pushes the ink within the nozzle. By varying the strength of the electric charge, different sized ink droplets can break away from the nozzle. In contrast, thermal ink heads have a heating element which creates a gas bubble in the nozzle chamber. The bubble creates the pressure needed to force a droplet of ink onto the media. In one embodiment, piezo ink printing technology is preferred, however, the present invention is not limited in this respect.

Solvent inkjet printers may be obtained from a variety of different suppliers and manufacturers, as the present invention is not limited in this respect. For example, Mimaki manufactures the JV3 which is a wide format printer. Other manufacturers include Gerber Scientific Products and their Jetster line of printers, Roland and their SOLJET PRO model solvent inkjet device, and Encad's VinylJet 36. Mutoh is another manufacturer that makes the Falcon line, a Hybrid line, and the Rockhopper II series of eco-solvent printers. It should be appreciated that the above list is only an exemplary list of printer manufacturers that produce printers for solvent inks. It should be appreciated that the present invention is not limited to solvent ink and/or ink printers from a particular supplier or manufacturer. It should also be appreciated that for thicker or larger applications, a wide format flatbed printer may be preferred to a roller printer. However, roller printers may be beneficial for thinner substrates.

Solvent inks may also be obtained from a variety of different suppliers and manufacturers, as the present invention is not limited in this respect. Many of the above printer manufacturers also make corresponding solvent inks. Another ink supplier for solvent inks is BullDog Products. Solvent inks generally dry by evaporation on the substrate, and the ink typically dries within a few minutes. Solvent inks come in a variety of colors such that the image formed from solvent inks may include colorful images.

In one embodiment, the solvent printing process is performed by H&H Digital Products. In this particular embodiment, the image is applied to the substrate with a Mutoh Hybrid flatbed printer. The normal speed of this particular printer is 800 sq.ft/hr. However, in one embodiment of the present invention, it is preferable for the printer to run at a slower speed, at approximately 120 sq.ft/hr, to print the image onto a substrate, such as a yoga mat.

In another embodiment, the image is applied to the substrate with ultraviolet (UV) curable inks. Similar to the solvent inks discussed above, UV curable inks may be printed using either a flatbed or a roller printer, and UV curable inks may also be used to print a digital image, such as a photo to a flexible substrate, such as a yoga mat. UV curable inkjet printing may be beneficial due to its fast curing rate, which leads to increased throughput. Further, UV curable inks may be beneficial because they typically do not dry until they are exposed to ultraviolet light.

UV curable inks and printers may be obtained from a variety of suppliers and printers. For example, in one embodiment, the UV curable ink image is formed onto the substrate by National Photo Imaging. Although there are a variety of printer manufacturers, in one embodiment, the image is formed with a T220UV flatbed printer called OCE-Arizona, and in some embodiments, Triangle Digital manufactures the ultraviolet pigmented ink.

Through experimentation, Applicant discovered that images with UV curable inks applied to substrates may behave more like the image and substrate shown in FIG. 1. In one embodiment, an image formed from UV curable inks rests on top of the substrate. Although there are certain applications where this may be satisfactory, in other embodiments, where the surface properties of the substrate are important to maintain, images with the above described solvent inks may be preferred over the use of UV curable inks.

Protective Layer

In one embodiment, a protective layer is further provided to prolong the life of the image on the substrate. However, it should be appreciated that in some embodiments, a protective layer is not required, as the present invention is not limited in this respect.

The protective layer may help prevent peeling, chipping or flaking of any portion of the image. In one embodiment, the protective layer is a thin plastic film, and may be applied in a thin spray, so as to minimally affect the surface properties of the substrate. In another embodiment, the protective layer may provide desired surface qualities.

According to one embodiment, the protective layer is a liquid lamination layer obtained from Neschen-Accutech. The protective layer may be a lacquer applied to the substrate using a vaporizing spray process which achieves a protective layer thickness between 0.003-0.005 inches. This small thickness is desirable to preserve the surface qualities of the substrate.

There are several models of equipment produced by Neschen-Accutech that may be compatible for coating flexible substrates. The Accu 40XUV and the Accu 40 are two example of older models, while the Accu 50XUV, and the Accu 72XUV are two examples of more recent models that form protective coatings over a substrate. The specification sheets for the Accu 50XUV, and the Accu 72XUV indicate that the resulting protective coating thickness for these machines are 0.5 mil and 0.4 mil, respectively. The normal speed in which this type of lamination layer would be applied through this equipment would be approximately 25 ft/min. However, in one embodiment of the present invention, the speed is reduced to approximately 6 ft/min so that the vapor spray penetrates the surface grooves/variations of the substrate. It should be appreciated that in some embodiments of the present invention, protective layers may be provided through various suppliers and manufacturers, as the present invention is not limited in this respect.

A light process may be used to cure the protective layer. For example, the protective layer may be cured with high intensity UV rays, and in one embodiment, a UV lacquer is used as the protective layer. This may be beneficial in certain embodiments, because UV curable laminates penetrate the surface of the substrate which may help to maintain the surface qualities of the substrate.

Although protective layers may come with both matte and gloss finishes, through testing, Applicant discovered that a protective layer with a matte finish may help to preserve the tacky surface qualities of a flexible substrate, in comparison to a similar protective layer with a gloss finish.

Flexible Substrate

The flexible substrate may be formed of a variety of materials. For example, the substrate may be made from various plastic and rubber materials. As explained below, the flexible substrate may be made from either an open cell or a closed cell plastic or rubber material, depending upon its desired application.

In one embodiment, the substrate is formed from a plastic foam. Generally, plastic foams are formed from a gas phase dispersed into a solid plastic phase. The solid plastic phase forms a plastic matrix which may include a base resin along with other compounding ingredients, such as plasticizers, stabilizers, surfactants, dyes, pigments, fire retardants, and fillers, etc. The gas phase is contained within this matrix and is commonly called the blowing or foaming agent.

Foams are typically classified as either open cell or closed cell. In closed cell foams most of the cells that form the matrix are generally spherical in shape and are completely enclosed by a thin wall or membrane of plastic. This is in contrast to open cell foams where the cells are interconnected. In a closed cell foam, the cell walls may act as a barrier to gases and liquids. Therefore, closed cell foams often have low water absorption and low water vapor permeability in comparison to open celled foams. Closed cell foams may be desirable in certain embodiments because they absorb little, if any, water and they can easily be cleaned and washed off.

Typical foams may be manufactured in a variety of ways, including physical, chemical, and mechanical approaches. For example, foams may be made by physical methods which include the expansion of a gas dissolved in a molten resin mixture by reducing the pressure. In a chemical process, the gas forming the cellular structure is a result of a chemical decomposition of the blowing agent. For example, in the production of some types of foamed polyvinylchloride (PVC), the decomposition of an organic nitrogen generates nitrogen gas which is used as the blowing agent. An example of a mechanical process includes mechanically mixing or whipping of gases into a polymeric material. As the material hardens, it entraps gas bubbles into the matrix. Some further examples of foam processing includes extrusion, injection molding, and continuous slab stock production by pouring. Other various methods of forming plastic foams should be apparent to one of ordinary skill in the art.

The base resin material forming the plastic foam may be either a thermoset or a thermoplastic material. Examples of thermoplastic foams include polystyrene (PS), polyvinylchloride (PVC), polyolefins (polyethylene and polypropylene), and Acrylonitrile Butadiene Styrene (ABS) foams. Examples of thermoset foams include polyurethane and epoxy foams. It should be appreciated that the above exemplary list of resin materials is not intended to be limiting, as the present invention may also incorporate other types of known resin materials.

In one embodiment of the present invention, the flexible substrate is formed into a closed cell foam material and is sized and shaped to form a yoga mat 50, as illustrated in FIG. 3 which depicts a user 40 in a typical yoga pose. As described above, some yoga mats are manufactured such that they exhibit a sticky or tacky surface. This type of surface is desirable because it reduces the amount of slipping and sliding across the yoga mat surface which is represented in FIG. 3 by arrows A and B. In one embodiment, this sticky surface is achieved through the manufacturing of the foam material, and may be formed from closed cell PVC foam. It should be appreciated that in other embodiments, this sticky surface may be obtained by the use of other materials, or through various surface treatments, and may, for example, include adhesive coatings, etc., or other processes performed after the substrate is manufactured.

In one embodiment, the substrate may include cushioning properties, and may be, for example, a yoga mat or an exercise mat. In other embodiments, such as with a wall panel, the substrate may be provided with sound insulating properties. In other embodiments, the substrate may include protective surfaces. For example, the substrate may be configured as a computer mouse pad and may be arranged to prevent the computer mouse from scratching the table. In other embodiments, the substrate may be configured as flooring, such as a door mat, a bath mat, or a pool mat, etc.

The size and thickness of the flexible substrate may vary based on its end use application, as the present invention is not limited in this respect. For example, in one embodiment, the substrate is rectangular extending approximately 3-7 feet in length, and 2-3 feet wide, with a thickness of approximately ⅛-1 inch. The above sizes may be applicable when the substrate is used as a mat for yoga, pilates, stretching, floor mats, etc. In one embodiment, the substrate is sized similar to a standard yoga mat having a width of approximately 60-70 cm, a length of approximately 180-190 cm, and a thickness of approximately 4-7 mm. In other embodiments, the flexible substrate may be smaller or larger, depending upon its application. For example, in one embodiment, where the flexible substrate is used as a large floor or wall mat, such as a gymnastics mat or a wrestling mat, the substrate may have a length and/or width of approximately 5 feet, 10 feet, 15 feet or 20 feet, or more. In other embodiments, the substrate may be sized to be much smaller. For example, the substrate may be sized to be a computer mouse pad. In such an embodiment, the substrate may be approximately 15-25 cm in length and width, with a thickness ranging from approximately 1-4 mm.

### EXAMPLE

As described above, according to one aspect of the present invention, an image is applied to the substrate and the surface qualities of the substrate are minimally affected. To quantify this aspect of the invention, Applicant had tests conducted by Massachusetts Institute of Technology (MIT). In particular, laboratory tests were conducted to quantify the stickiness or tackiness associated with the outer surface of a yoga mat with various types of printed images and/or surface coatings.

Five yoga mats were tested. Each yoga mat was designated a material number as designated below:

| Material No. | Description of Yoga Mat |
|---|---|
| 1 | Conventional closed cell PVC yoga mat (sticky mat) |
| 2 | Closed cell PVC yoga mat with silk screened text images |
| | across mat |
| 3 | Closed cell PVC yoga mat with solvent ink image covering |
| | entire surface of mat |
| 4 | Closed cell PVC yoga mat with UV curable ink image |
| | covering entire surface of mat |
| 5 | Closed cell PVC yoga mat with solvent ink image covering |
| | entire surface of mat with a protective lamination layer |

Material No. 1 is a conventional closed cell PVC yoga mat, which is commonly referred to as a “sticky mat” due to its tacky outer side. Material No. 2 is also a closed cell PVC yoga mat, however, Material No. 2 has a silk screened text image on top of the sticky outer side. Material No. 3 is a closed cell PVC yoga mat featuring a solvent ink image as described above under the present invention. Material No. 4 features a closed cell PVC yoga mat with a UV curable image as described above. Finally, Material No. 5 features a closed cell PVC yoga mat similar to Material No. 3 with the solvent ink image. However, Material No. 5 also includes a protective lamination layer.

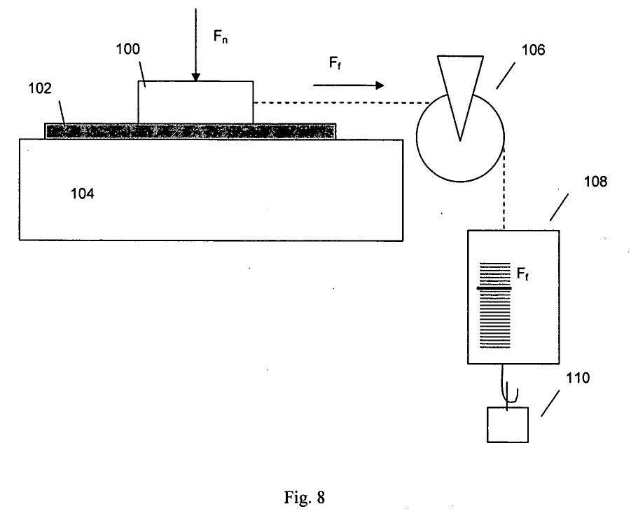

Experiments were conducted at MIT to quantify the tackiness of the materials. There are no standard testing procedures for measuring the “tackiness” of a material. Therefore, a new procedure was formulated and is described below. FIG. 8 illustrates the experimental procedure. The mat 102 is placed on top of a granite counter 104. No tape or adhesive was necessary to secure the mat 102 to the counter 104, because during the experiment, the mat did not move with respect to the counter. An object 100 is placed on top of the mat 102 to simulate a human skin surface (hand, foot, etc.).

Both the stiction force and the static coefficient of friction were measured to quantify the tackiness. “Stiction” is a compound word for “static friction”. The stiction force is a measure of the amount of force needed to start to move the object 100 along the mat 102. In other words, the stiction force equals the frictional or lateral force required to translate the object 100 along the mat 102. In FIG. 8, the stiction force is represented by arrow F_{f}. The static coefficient of friction is defined as the ratio between the stiction or lateral force, F_{f}, and the normal or perpendicular force on the object 100. The normal force is defined as the force acting on the object 100, and is represented as arrow Fₙ in FIG. 8. Therefore, the static coefficient of friction may be defined as:
μₛ=F_{f}/Fₙ
where F_{f} and Fₙ are the lateral and normal (perpendicular) forces, respectively.

The static coefficient of friction (μs) is defined by both the mat material 102 and the material comprising the object 100 through which the normal and lateral forces are applied. Therefore, for testing, an object 100 was selected to have surface properties similar to that of human skin. For this reason, the translating object 100 was unskinned (i.e. still has skin on), cleaned, and dried segments of chicken. In particular, chicken drumsticks, readily available from a grocery store were used as the object 100. The drumsticks were left with the skin on, washed with water, and towel dried. It is important to note that the skin on the drumstick was tightly attached to the muscle and bone portions of the drumstick, such that the skin could not readily slide relative to the muscle or bone. The drumsticks were left out on a dry towel for about 20 minutes to dry while the experiment equipment was set up. Once the chicken was dry to touch, three drumsticks were bundled together near the joint end with nylon string to form the object 100. As shown in FIG. 8, nylon string was also used to secure the three drumsticks to the weight 110 through pulley 106.

The mass m of this object 100 was 0.423 kg, corresponding to Fₙ=mg=4.1 N. The lateral stiction force F_{f} was obtained through a pulley 106, a calibrated spring scale 108 and weight 110, as illustrated in FIG. 8. Both the pulley 106, spring scale 108, and weight 110, are all readily available standard laboratory equipment. Only the upper body contacting surfaces of the mat materials 102 were tested. The experiments were conducted at ambient temperature and humidity. The contact area between the object 100 and the mat 102 was constant for all samples and measured as 90 cm², which is approximately the area of a palm of a hand. In particular, the contact area was measured by placing the object (three chicken drumsticks) into a plastic bag and on top of a piece of graph paper. The outer boundary of the portion of the object touching the graph paper was traced to form the contact area. The area of the traced region was calculated to determine the contact area.

The resulting stiction force (F_{f}) and static coefficient of friction (μₛ) for each of the above five materials are shown in Table 1 below. The error represents the standard deviation among four consecutive measurements for each sample.

TABLE 1
Experimentally determined stiction force, F_{f}, and static
coefficient of friction, μₛ.

| Material No. | Fₙ [N] | F_{f} [N] | μₛ |
|---|---|---|---|
| 1 | 4.10 | 4.88 +/− 0.22 | 1.19 |
| 2 | 4.10 | 3.88 +/− 0.22 | 0.95 |
| 3 | 4.10 | 4.63 +/− 0.42 | 1.12 |
| 4 | 4.10 | 2.88 +/− 0.44 | 0.70 |
| 5 | 4.10 | 5.50 +/− 0.50 | 1.34 |

As illustrated in Table 1, the stiction force and the static coefficient of friction relative to a skin-like surface varied among the five materials. The static coefficient of friction relative to this skin-like surface for Material No. 1 of 1.19 indicates a baseline level for the tackiness associated with a conventional yoga mat with no images. Notably, the yoga mat with the silk screened image (Material No. 2) has a static coefficient of friction that is reduced to 0.95. This data quantifies how silk screening affects the tackiness of a substrate. More particularly, it shows how this particular silk screened image reduced the tackiness of the substrate (as defined by the static coefficient of friction) by about 20%. Also, it should be noted that because this mat had silk screened text images, portions of the mat were not covered with silk screening. If the mat featured a silk screened image over a larger portion of the mat, it would be expected that the static coefficient of friction would be even lower.

In contrast, the solvent ink image of Material No. 3, as described under one embodiment of the present invention exhibits a static coefficient of friction relative to a skin-like surface of 1.12, which is only about 6% less than the conventional mat. The solvent ink image in Material No. 3 covers the entire surface of the mat. Because the difference between the data for the conventional mat and the solvent ink image mat does not exceed the standard deviation of these measurements, the experiment indicates that Material No. 1 and No. 3 exhibit approximately the same coefficient of friction values. Therefore, the solvent ink image of Material No. 3, which is at least partially embedded into the mat, minimally affects the surface properties of the mat.

Turning to Material No. 5 which has the solvent ink image and the protective layer, the static coefficient of friction was 1.34, which is slightly higher than the conventional yoga mat of Material No. 1. Therefore, in some embodiments, the protective layer may assist in maintaining the surface properties of a tacky mat. However, it is noted that this may be due, at least in part, to the measurement error. Nevertheless, the experiments illustrate that the tackiness of the mats featuring the solvent ink images (with or without the protective layer) are higher than the mats with the silk screened image.

Finally, the yoga mat having the UV curable ink image of Material No. 4 had a static coefficient of friction relative to a skin-like surface of 0.70. This is somewhat expected, because as described above, unlike solvent inks which are at least partially embedded in the substrate, UV curable inks generally sit more on top of a substrate. Accordingly, the surface properties of the mat may be affected more by a UV curable image. Nevertheless, the UV curable ink mat still exhibited a static coefficient of friction relative to a skin-like surface that was only reduced by about 40%. Although this may not be desirable for embodiments where the tackiness of the substrate is important, substrates featuring images made with UV curable inks may be advantageous for other applications, such as non-tacky applications like insulation panels, computer mouse pads, wall covering, floor covering, etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A mat, comprising:
a flexible sheet of plastic foam that a user may manually by hand roll up and unroll, repeatedly, said flexible sheet including a first tacky side defining a user contacting side and a second side defining a ground contacting side; and
said first tacky side of said flexible sheet including an intermediate body portion and an external border portion surrounding said intermediate body portion, wherein said sheet incorporates a digital image along at least a portion of said body portion, and wherein said sheet incorporates said image along at least about 25% of said first tacky side of said flexible sheet.

2. The mat of claim 1, wherein said sheet incorporates said image along at least about 50% of said first tacky side of said flexible sheet.

3. The mat of claim 1, wherein said sheet incorporates said image along at least about 75% of said first tacky side of said flexible sheet.

4. The mat of claim 1, wherein said sheet incorporates said image along about 100% of said first tacky side of said flexible sheet.

5. The mat of claim 1, wherein said image is at least partially embedded into said first tacky side.

6. The mat of claim 5, wherein said image is formed with solvent inks.

7. The mat of claim 1, wherein said image is formed with UV curable inks.

8. The mat of claim 1, further comprising a protective layer applied to said image.

9. A flexible substrate, comprising:
a sheet of flexible material, that a user may manually by hand roll up and unroll, repeatedly, the sheet having a first side having a surface tackiness defined by a static coefficient of friction relative to a skin-like surface; and
at least a portion of said first side incorporating an image, wherein the surface tackiness of said first side of said sheet is minimally affected by said image, such that said static coefficient of friction relative to a skin-like surface of said first side at a location of said image is at least about 80% of the static coefficient of friction of a first side of a same type sheet of flexible material without an image.

10. The flexible substrate of claim 9, wherein said static coefficient of friction relative to a skin-like surface of said first side with said image is at least about 85% of the static coefficient of friction of the first side without the image.

11. The flexible substrate of claim 10, wherein said static coefficient of friction relative to a skin-like surface of said first side with said image is at least about 90% of the static coefficient of friction of the first side without the image.

12. The flexible substrate of claim 11, wherein said static coefficient of friction relative to a skin-like surface of said first side with said image is at least about 95% of the static coefficient of friction of the first side without the image.

13. The flexible substrate of claim 9, further comprising a thin protective coating on said image.

14. The flexible substrate of claim 9, wherein said image is embedded into at least about 25% of said first side of said sheet of flexible material.

15. The flexible substrate of claim 9, constructed and arranged for use as a yoga mat.

16. The flexible substrate of claim 9, wherein said image is formed with solvent inks.

17. The flexible substrate of claim 9, wherein said sheet of flexible material is closed cell PVC foam.

18. A method of applying an image to a flexible substrate, the method comprising the steps of:
providing a flexible substrate that a user may manually by hand roll up and unroll, repeatedly, wherein said flexible substrate has a first tacky side; and
applying an image to said first tacky side, wherein said image is formed from an ink, and said ink is applied such that said ink becomes at least partially embedded into said flexible substrate.

19. The method of claim 18, further comprising the step of applying a thin protective coating onto said first tacky side after said image is applied to said first tacky side.

20. The method of claim 18, wherein said image applied to said first tacky side is a digital image.

21. The method of claim 18, wherein said image is formed with a solvent ink.

22. A mat, comprising:
a flexible sheet that a user may manually by hand roll up and unroll, repeatedly, the flexible sheet having a first side defining a body contacting surface, and a second outer surface defining a ground contacting surface; and
an image at least partially embedded into said first side, wherein said image is formed from a solvent ink.

23. The mat of claim 22, further comprising a protective layer applied to said image.

24. The mat of claim 22, wherein said flexible sheet is PVC foam.

25. The mat of claim 22, wherein said image is a digital image.

26. The mat of claim 22, wherein said mat is constructed and arranged to be a yoga mat.
